(19) United States
(12) Patent Application Publication
(10) Pub. No.: US 2006/0178893 A1
(43) Pub. Date: Aug. 10, 2006

(54) System and method for brokering requests for collaboration

(76) Inventors: David P. McCallie JR., Stilwell, KS (US); Christopher S. Finn, Liberty, MO (US); David J. O'Larte, Peculiar, MO (US); Steven S. Crooks, Gladstone, MO (US)

Correspondence Address: SHOOK, HARDY & BACON L.L.P.;Intellectual Property Department, 2555 GRAND BOULEVARD, KANSAS CITY, MO, 64108-2613, US

(21) Appl. No.: 11/027,483

(22) Filed: Dec. 30, 2004

(51) Int. Cl. G06Q 99/00

(52) U.S. Cl. 705/1

(57) ABSTRACT

A system and associated methods facilitate brokering on behalf of a particular clinician of requests for an electronic collaboration session that originate from another entity. According to one method of the invention, inbound messages are received by a brokering system, and then converted into a format suitable for screening. Each inbound message relates to a request of collaboration with the particular clinician. Converted messages are then screened according to certain rule settings of the system to reach a particular result. Based on the result of the screening, a response is generated to the converted message that includes invoking a specific rule action. The rule actions may be configured to accomplish a range of automated functions, and the brokering system allows the particular clinician to specify a particular level of presence for collaboration.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

The present invention relates generally to the field of computer software. More particularly, the present invention relates to a computerized system and method for brokering requests for collaboration with a particular clinician where the requests originate with a requesting entity.

Clinicians have traditionally engaged in a certain level of collaboration with one another to improve the delivery of patient-focused healthcare services. For example, clinicians may collaborate about certain diagnostic test results for a given patient, or may simply be seeking approval for a prescription refill. Such a collaboration session often involves clinicians meeting face-to-face or over the telephone.

With the advent of new technologies, it is now possible for clinicians to be in contact with one another remotely through, for example, portable electronic devices that facilitate new communication schemes such as instant messaging or shared whiteboards, among others. These techniques have the potential to provide a more adaptive and efficient work environment, with increased clinician accessibility and ad hoc collaboration. The increased level of accessibility, however, also brings with it a greater potential for interruption and distraction of the clinicians. While a clinician is occupied with a current clinical task or situation, he or she may not want to engage in a collaboration session with another clinician. Moreover, the clinician may only have access to certain types of communication, such as text messaging. Even if unavailable, the clinician may be aware that those seeking collaboration may be asking a routine question or seeking approval for a fairly standard clinical action. In such cases, it would be desirable to allow certain “pre-programmed responses,” if warranted by the situation. Even if a request is of a more complex nature, such that a pre-programmed response is not feasible, there may be other clinicians within the system suitable and available for collaboration. One current approach is a system that merely notes whether a clinician is available for collaboration or not. However, the situations described above often require a better solution than those currently offered.

A system is needed that takes advantage of advances in communication methods, while providing a measured level of direct accessibility that may be controlled by a given clinician, as well as selected automation of responses.

### BRIEF SUMMARY OF THE INVENTION

The present invention generally provides a system and associated methods that accomplish brokering of requests for an electronic collaboration session with a particular clinician that originate from another entity. The brokering of requests may, in certain circumstances, depend on accessibility of the particular clinician, and may depend upon the context of the request.

One aspect of the present invention includes a method in a computer system of brokering an inbound message on behalf of a particular clinician. According to the method, inbound messages are received by the system, and are converted into a format suitable for screening. Each inbound message relates to a request for collaboration with the particular clinician. Converted messages are then screened according to rule settings of the system and are compared against known facts to reach a particular result. Based on the result of the screening, a response is generated to the converted message that includes invoking a specific rule action.

Another aspect of the present invention includes a computer system for performing brokering on behalf of a particular clinician of inbound messages requesting collaboration. The computer system has a message handing component that receives an inbound message and coverts the message into a format suitable for screening. The converted message is communicated to a rule engine component that screens the converted message according to rule settings of the system to reach a particular result. A responder component may be employed to invoke a specific rule action based on the particular result reached by the rule engine component.

### BRIEF DESCRIPTION OF THE SEVERAL VIEWS OF THE DRAWING

In the accompanying drawings which form a part of the specification and are to be read in conjunction therewith and in which like reference numerals are used to indicate like elements in the various views:

FIG. 1 is a block diagram of an exemplary computing system suitable for use in implementing the present invention;

FIG. 2 is a block diagram of one embodiment of a system of the present invention for brokering collaboration requests on behalf of clinicians;

FIGS. 3a and 3b are flow diagrams of one method for brokering collaboration requests utilizing the system of FIG. 2;

FIG. 4 diagramically illustrates one exemplary collaboration brokering scenario;

FIG. 5 diagramically illustrates another exemplary collaboration brokering scenario.

### DETAILED DESCRIPTION OF THE INVENTION

The present invention provides a system and associated methods that facilitate brokering of inbound electronic messages on behalf of a particular clinician, where the inbound messages are of the type requesting collaboration with the particular clinician. Through the present invention, requests for ad hoc collaboration sessions between a requesting entity and a clinician received through electronic communication may be analyzed to determine, in one embodiment, whether the request should be presented to the clinician, whether to respond to the request for collaboration, and how to give the most appropriate response. This allows such ad hoc collaboration to take advantage of automation techniques in electronic communication systems while maintaining a desired level of accessibility within a healthcare communication network (referred to generally as the “network”). Among other advantages, the functionality provided by the various embodiments of present invention serves to: (1) provide clinicians more control of their “presence” or accessibility, for collaboration with requesting entities within the network, including various levels of presence; (2) give clinicians and/or the appropriate healthcare institutional entities the ability to create dynamic responses to a range of requests related to the delivery of care that typically come from other clinicians or entities within the network; (3) permit control over the routing and post-processing behavior of collaboration requests; and (4) facilitate the negotiation of communication capabilities between an electronic device of the entity requesting collaboration and the electronic device associated with the clinician sought by the requesting entity, to eliminate the need to respond in situations where the device capabilities are incompatible. As such, the system of the present invention adapts to the nature of the environment in which collaborative communications take place.

### General Computing System Environment

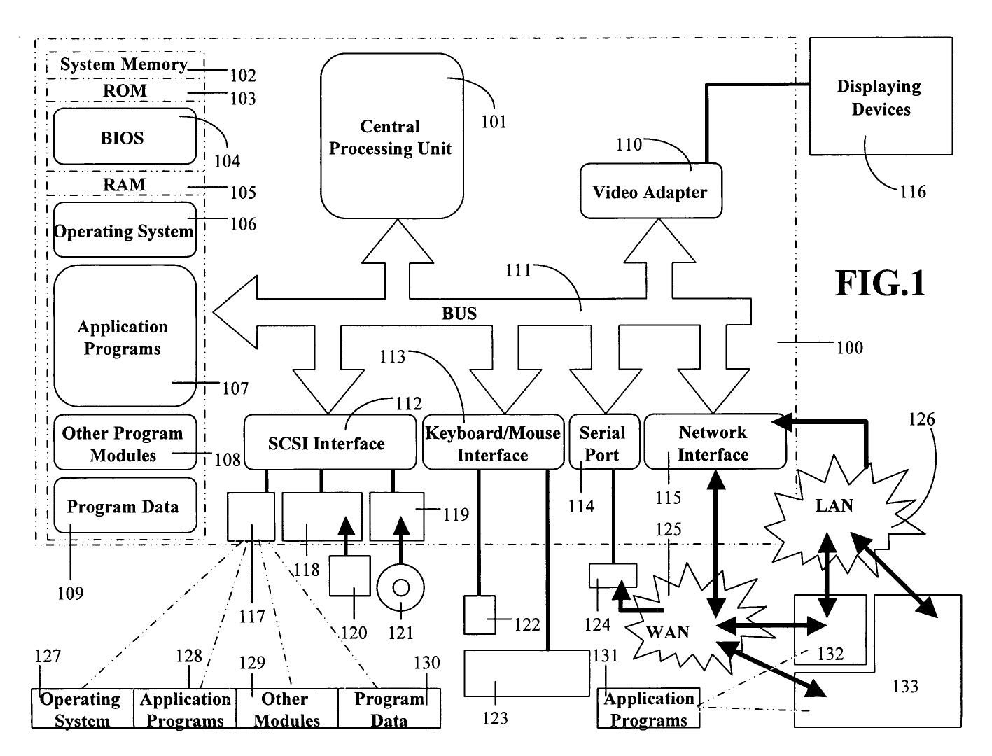

FIG. 1 illustrates an example of a suitable computing system environment in which the invention may be implemented. The computing system environment is only one example of a suitable computing environment and is not intended to suggest any limitation as to the scope of use or functionality of the invention. Neither should the computing system environment be interpreted as having any dependency or requirement to any one or combination of components illustrated in the exemplary operating environment.

The present invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, cellular telephones, portable wireless devices, multiprocessor systems, microprocessor-based systems, programmable consumer electronics, network PCs, minicomputers, mainframe computers, distributed computing environments that include any of the above systems or devices, and the like.

The present invention may be described in the general context of computer-executable instructions, such as program modules, being executed by a computer. Generally, program modules include routines, programs, objects, components and data structures that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the invention includes a general purpose computing device in the form of a computer 100. Computer 100 serves at least in part as a general medical information system. Components of computer 100 include, but are not limited to, a processing unit 101, a system memory 102, and a system bus 111 that couples various system components including the system memory 102 to the processing unit 101. The system bus 111 may be any of several types of bus structures including a memory bus or memory controller, a peripheral bus and a local bus using any of a variety of bus architecture. By way of example, and not limitation, such architectures include Industry Standard Architecture (ISA) bus, Micro Channel Architecture (MCA) bus, Enhanced ISA (EISA) bus, Video Electronics Standard Association (VESA) local bus, and Peripheral Component Interconnect (PCI) bus also known as Mezzanine bus.

Computer 100 typically includes a variety of computer readable media. Computer readable media can be any available media that can be accessed by computer 100 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is mot limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 100. Communications media typically embodies computer readable instructions, data structures, program modules or other data in a modulated data signal such as a carrier wave or other transport mechanism and includes any information delivery media. The term “modulated data signal” means a signal that has on or more of its characteristics set or changed in such a manner as to encode information in the signal. By way of example, and not limitation, communication media includes wired media such as a wired network or direct wired connection, and wireless media such as acoustic, radio frequency (RF), infrared and other wireless media. Combinations of any of the above should also be included within the scope of computer readable media.

The system memory 102 includes computer storage media in the form of a volatile and/or nonvolatile memory such as read only memory (ROM) 103 and random access memory (RAM) 105. A basic input/output system (BIOS) 104, containing the basic routines that help to transfer information between elements within computer 100, such as during start-up, s typically stored in ROM 103. RAM 105 typically contains data and/or program modules that are immediately accessible to and/or presently being operated on by processing unit 101. By way of example, and not limitation, FIG. 1 illustrates operating system 106, application programs 107, other program modules 108, and program data 109.

The computer 100 may also include other removable/nonremovable, volatile/nonvolatile computer storage media. By way of example only, FIG. 1 illustrates a hard disk drive 117 that reads from or writes to nonremovable, nonvolatile magnetic media, a magnetic disk drive 118 that reads from or writes to removable, nonvolatile magnetic disk 120, and an optical disk drive 119 that reads from or writes to a removable, nonvolatile optical disk 121 such as a CD-ROM or other optical media. Other removable/nonremovable, volatile/nonvolatile computer storage media that can be used in the exemplary operating environment include, but are not limited to, magnetic tape cassettes, flash memory cards, digital video disks, digital video tape, Bernoulli cartridges, solid state RAM, solid state ROM, and the like. The hard disk drive 117, magnetic disk drive 118 and optical disk drive 119 are typically connected to the system bus 111 by a Small Computer Systems Interface (SCSI) 112. Alternatively, the hard disk drive 117, magnetic disk drive 118 and optical disk drive 119 may be connected to the system bus 111 by a hard disk drive interface, a magnetic disk drive interface, and an optical drive interface, respectively.

The drives and their associated computer storage media discussed above and illustrated in FIG. 1, provide storage of computer readable instructions, data structures, program modules and other data for the computer 100. In FIG. 1, for example, hard disk drive 117 is illustrated as storing operating system 127, application programs 128, other program modules 129, and program data 130. Note that these components can either be the same as or different from operating system 106, application programs 107, other program modules 108, and program data 109. A user may enter commands and information into the computer 100 through input devices such as a keyboard 123 and pointing device 122, commonly referred to as a mouse, trackball or touch pad. Other input devices (not shown) may include a microphone, joystick, game pad, satellite dish, scanner, or the like. These and other input devices are often connected to the processing unit 101 through a user input interface 113 or a serial port interface 114 that is coupled to the system bus 111, but may be connected by other interface and bus structures, such as a parallel port, game port or a universal serial bus (USB). A monitor 116 or other type of display device is also connected to the system bus 111 via an interface, such as a video adapter 110. In addition to the monitor 116, computers may also include other peripheral output devices such as speakers and printers, which may be connected through an output peripheral interface.

The computer 100 may operate in a networked environment using logical connections to one or more remote computers, such as a remote computer 133 and/or other communications, such as a communication device 132. The remote computer 133 may be a personal computer, a server, a router, a network PC, a peer device or other common network node, and typically includes many or all of the elements described above relative to the computer 100, although only a memory storage device has been illustrated in FIG. 1. Remote computer 133 may, for example, be found at a variety of health system related locations, such as hospitals, other inpatient settings, pharmacies, a clinician's office, ambulatory settings, testing labs and a patient's home environment, though other locations may be chosen as well. The communication device 132 may be a mobile cellular phone, mobile text-pager or other portable communications device, and typically includes some of the elements described above relative to the computer 100. The logical connections depicted in FIG. 1 include a local area network (LAN) 126 and a wide area network (WAN) 125, but may also include other networks. Such networking environments are commonplace in offices, enterprise-wide computer networks, intranets and the Internet.

When used in a LAN networking environment, the computer 100 may be connected to the LAN 126 through a networking interface or adapter 115. When used in a WAN networking environment, the computer 100 typically includes a modem 124 or other means for establishing communications over the WAN 125, such as the Internet. The modem 124, which may be internal or external, may be connected to the system bus 111 via the serial port interface 114 or other appropriate mechanism. In a networked environment, program modules depicted relative to the computer 100, or portions thereof, may be stored in the remote storage device. By way of example, and not limitation, FIG. 1 illustrates remote application programs 131 as residing on memory devices 132 and 133. It will be appreciated that the network connections shown are exemplary and other means of establishing a communications link between the computers and/or portable communication devices may be used.

Although many other internal components of the computer 100 are not shown, those of ordinary skill in the art will appreciate that such components and the interconnection are well known. Accordingly, additional details concerning the internal construction of the computer 100 need not be disclosed in connection with the present invention.

Those skilled in the art will understand that program modules such as the operating system 106 and 127, application programs 107 and 128, and program data 109 and 130 are provided to the computer 100 via one of its memory storage devices, which may include ROM 103, RAM 105, hard disk drive 117, magnetic disk drive 118 or optical disk drive 119. Preferably, the hard disk drive 117 is used to store program data 130 and 109, application programs 107 and 128, and operating system 106 and 127.

When the computer 100 is turned on or reset, the BIOS 104, which is stored in the ROM 103 instructs the processing unit 101 to load the operating system from the hard disk drive 117 into the RAM 105. Once the operating system 127 is loaded in RAM 105, the processing unit 101 executes the operating system code and causes the visual elements associated with the user interface of the operating system 127 to be displayed on the monitor 116. When an application program 107 and 128 is opened by a user or when an inbound request for collaboration is received, the program code and relevant data are read from the hard disk drive 117 and stored in RAM 105.

### Request Brokering

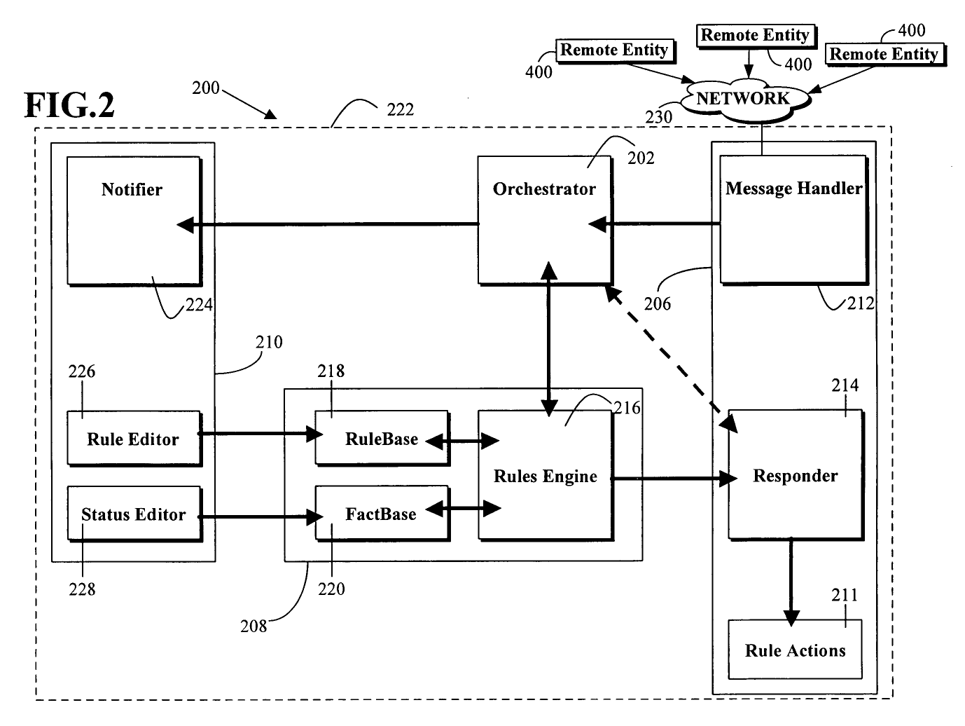

One embodiment of a system 200 of the present invention providing brokering of collaboration requests for a clinician is illustrated with reference to FIG. 2. Various terminology discussed with respect to the present invention may have particular meaning as described below. For instance, the term “clinician” includes, but is not limited to, a treating physician, specialists such as surgeons, radiologists and cardiologists, emergency medical technicians, physician's assistants, nurse practitioners, nurses, physical therapists, pharmacists, dieticians, microbiologists, and the like, and aides or assistants thereto. The term “patient” refers to a person that is receiving or has received health-care-related services in any location in a medical environment (e.g., hospitals or other inpatient or outpatient settings, a clinician's office, ambulatory settings, testing labs, a patient's home environment, or in any other setting). The system 200 may interact with various types of informational databases containing certain general medical information, as well as interacting with medical records that contain information about patients. As an example, these medical records may take the form of an electronic medical record (EMR) for a particular patient. The electronic medical record is typically designed to contain various types of information about an individual patient, such as: observed conditions of the patient (e.g., physiological conditions such as blood pressure, oxygen saturation levels in blood, or other “vital signs”); medications taken; current immunizations; food and drug allergies; diagnoses of various clinicians; listing of clinician names that are currently providing or that have provided care to the patient; and may include, directly in the EMR or attached thereto, other files containing various information/data, such as image data (e.g., X-ray, MRI image, skin or tissue photos), voice data (e.g., .wav file or other audio formatted recording of the clinician providing patient-related information), or other textual information. The information in an EMR or other medical record as described herein may be referred to generally as patient-focused clinical data. However, it should be understood that the term “medical record,” or “electronic medical record” in particular, should not be interpreted to be limited to any type of computer-readable format or record, but includes any electronically-stored data structure containing information relative to at least one specific patient and from which information may be viewed and/or extracted by the system of the present invention. The term “entity” or “requesting entity” includes, but is not limited to, the broad category of clinicians, and includes other ancillary personnel that may desire collaboration with the particular clinician sought for a collaboration session (the “collaborating clinician”), as well as institutional entities that manage information within a healthcare network or other care delivery system. The components of system 200 operate within a communication device 222, except as noted below for certain alternative embodiments. The device 222 is associated with a clinician with whom others may wish to collaborate. In other words, the clinician has access to device 222. Other clinicians may wish to collaborate, and are schematically represented as remote entities 400. Remote entity 400 communicates with device 222 through a network 230, as more fully described below. The system 200 will first be described, followed by a description of the method and some examples of use.

Finally, it should be understood that the term “collaboration request” describes inbound message content that relates to a request (by a requesting entity) to communicate directly with a collaborating clinician and indirectly with a proxy service that, in accordance with pre-established rules of the collaborating clinician and the institution, has certain automated functionality to perform certain tasks or provide specific information to the requesting entity. For instance, one example of a direct collaboration request would be a primary care physician desiring for a radiologist located remotely in the health care network to concurrently view an electronic image of an X-ray. An example of an indirect request includes a nurse seeking refill approval from a physician for a prescription medication for a patient, with the physician having established certain settings within the system 200 such that approval may be given automatically if certain criteria are met (e.g., the medication refill is not contraindicated). The system 200 includes an orchestrator 202 that coordinates the flow of electronic information between an input/output (I/O) and action subsystem 206, a rules subsystem 208 and a user interface subsystem 210 to achieve brokering of requests on behalf of the collaborating clinician.

The primary function of orchestrator 202 is to coordinate the communication flow between and among the various component subsystems 206, 208 and 210. As explained in further detail below, orchestrator 202 initializes the rules subsystem 208 to receive information from the user interface subsystem 210 about a communication device 222 associated with the collaborating clinician, as well as other clinician-related information. Orchestrator 202 also receives converted messages from I/O and action subsystem 206 requesting collaboration, invokes the rules subsystem 208 to process the converted message and determine an appropriate result, and optionally communicates this to the user interface subsystem 210. Further, orchestrator 202 may communicate with the user interface subsystem 210 to alert the clinician about inbound messages requesting collaboration.

As illustrated in FIG. 2, subsystem 206 includes a message handling component 212. Component 212 is adapted to receive electronic communications in the form of inbound messages from any number of communication devices of remote entities 400 requesting collaboration with a clinician. The inbound message may travel directly from another clinician (remote entity 400) or through a centralized message service or other router designed to contact the system 200. In any event, the inbound message travels from the device of remote entity 400 through network 230 to message handling component 212. In an embodiment, XMPP/Jabber, Microsoft RTC and other message services may be employed. Message handling component 212 converts, or de-serializes, the inbound message into a format understood by the system 200 and that is suitable for presentation to rules subsystem 208. The de-serialization step may include decrypting the inbound message and formatting into an in-memory format. An example of this conversion is discussed below. Message handling component 212 may also generate and send a reply message to the communication device of the requesting clinician (remote entity 400) providing notice that the request for collaboration was received by the system 200.

I/O and action subsystem 206 also includes a responder component 214 that invokes, when appropriate, the performance of one or more rule actions 211. For purposes of illustration, exemplary rule actions 211 may include notifying the requesting entity of the accessibility or presence of the collaborating clinician; establishing a two-way communication channel or link between the entity 400 and the device 222; forwarding a collaboration request to a third party; and approving of a request made by the requesting entity, among others. Those of skill in the art will appreciate that many types of rule actions 211 may be invoked to provide any collaboration and information exchange of various types, and the present invention is not to be limited to the specific examples provided herein. The responder component 214 may also notify both the requesting entity 400 and the collaborating clinician associated with the device (through UI subsystem 210) about a specific rule action 211 that has been invoked (unless the rule action 211 provides the notice). Preferably, the responder component 214 is extensible so that rule actions 211 may be supplemented or altered.

Rules subsystem 208 conducts the processing, or screening, of the inbound message converted by message handling component 212. This converted message is routed to subsystem 208 by orchestrator 202. More specifically, subsystem 208 includes a rules engine component 216. Rules engine component 216 performs the processing, or screening, of the converted message and reaches a particular result based on a comparison of the content of the inbound message against certain clinical rule settings. As one example, the converted message may contain formatted information extracted from the original inbound message, including target context such as a patient identifier, and clinical context such as patient-specific clinical data associated with the identified patient. This information is then processed by component 216.

The rule settings are composed of a hierarchy of criteria defined in a database of rules in a rulebase 218 and various fact-based data stored in a fact database 220. Categories of rules in the rulebase 218 generally include both gating rules and customized rules. As a general proposition, gating rules are evaluated before customized rules, and triggering of certain gating rules may cause rules engine component 216 to reach a particular result without regard to the customized rules, or at least by evaluating only a certain subset of customized rules. Upon initialization of the rules engine component 216, the information in rulebase 218 and factbase 220 is loaded into the component 216 so that converted message processing may take place. Both gating rules and customized rules are capable of being imported and exported from rulebase 218, as more fully described below, to permit editing and sharing of data within rulebase 218. Gating and customized rules are also preferably represented in a portable format to facilitate such sharing. (e.g., by taking advantage of a unique identifier approach, such as Uniform Resource Identifiers).

Gating rules rely on information in the factbase 220 regarding clinician “presence” within a network. Examples of presence include availability of the clinician selected for collaboration and the current communication capability of a communication device 222 associated with the collaborating clinician. The communication device 222 may be similar to communication device 132 or remote computer 133 connected with a network of the health care system or institution (e.g., WAN 125 or LAN 126), and may include a portable device more permanently associated with a given collaborating clinician or a device affixed at a certain location and temporarily associated with the clinician if they are found to be at that location (e.g., a voice-controlled interface in an operating room). The first type of gating rule allows the collaborating clinician to establish whether the clinician will accept any type of collaboration request, and if so, how collaboration may take place (e.g., desiring only a text chat on a PDA with speech and text capabilities), and with which entities collaboration will be accepted (e.g., nurses within my practice group only). The second type of gating rule involves determining the appropriate type of communication channel for collaboration (e.g., voice, text, graphical). In this type of gating rule, instead of being influenced by clinician preferences, capabilities are determined by the constraints of the communication device 222 and its current location. For example, if collaboration about a patient's X-ray image is requested, and the collaborating clinician's device 222 is a pager incapable of displaying such an image, then the requested collaboration is not possible. This situation will be determined by rules engine 216. In another example, the location of the device may be determined by GPS or LAN-based positioning systems in the device and associated with rules for the current location. For example, locations at or near the clinician's office or hospital may require different rules than the clinician's home. Alternatively, the schedule of the clinician may determine the likely location of the clinician and affect the gating rules.

Customized rules may be established by the collaborating clinician and/or by the institution or healthcare system in which the collaborating clinician is practicing. For instance, the collaborating clinician may create a rule that allows for automated approval of certain categories of requests assuming medical and other precautions are observed (e.g., approval if a medical refill request does not trigger an alert for a drug-drug interaction based on information in the patient's EMR regarding medications currently taken). An example of an institutional customized rule is the implementation of a “web of care” evaluation. This could be triggered when a gating rule determines, for example, that a collaborating clinician is not “present” on the network, and the customized rule requires a secondary clinician (i.e., third party) for collaboration regarding a particular patient or a particular piece of clinical context. The particular secondary clinician may be chosen for collaboration through an evaluation of the quantitative measurement of the relationship between the secondary clinician and the patient. This relationship may take into account a number of factors, including the quality, nature, and frequency of contact or care given by the secondary clinician for the patient, as is explained in U.S. Patent Application Ser. No. 60/509,003, filed Oct. 6, 2003, and entitled “System and Method For Creating a Visualization Indicating Relationships and Relevance to an Entity,” the teachings of which are incorporated herein by reference. Thus, a secondary clinician within the “web of care” would be chosen and contacted about the collaboration request. Rules engine component 216 may also request information from a data source remote from the system 200 in order to implement the customized rules to process the converted message. An example of such a data source would be a database holding medical information, such as the MULTUM database of Cerner Multum, Inc. containing information about drug-drug interactions.

Once the rules engine component 216 completes processing of the converted message, a communication including this information is routed through orchestrator 202 to the responder component 214 to determine which, if any, rule action 211 should be invoked based on the message processing results. In another embodiment, the rules engine component 216 communicating the message processing results directly to responder component 214 for determination of any rule actions 211 to be invoked. Responder component 214 may invoke more than one rule action 211 depending on the results determined by the rule engine component 216.

User interface subsystem 210 provides various notifications regarding collaboration requests and rule action activity, as well as the ability to edit certain information within rulebase 218 and factbase 220. More specifically, user interface subsystem 210 includes a notifier 224, a rule editor 226 and a status editor 228.

Notifier 224 informs the clinician associated with device 222 about collaboration requests and the results of request processing by the system 200. More specifically, notifier 224 may use a variety of mechanisms, such as audible, textual and other visual indicators on the clinician's communication device 222, to alert the clinician of an inbound message requesting collaboration. If the communication device 222 is one having a graphical user interface, such as a laptop or PDA, notifier 224 may provide a visual indication through a pop-up window containing textual information. A variety of audio and/or visual indicators may be employed. Additionally, if the communication device 222 is equipped with email or messaging-type software, notifier 224 may be configured to generate a compatible message based on the particular rule action 211 that was invoked.

Rule editor 226 provides an interface allowing the ability to import and export the gating rules and customized rules with respect to rulebase 218. Status editor 228 provides an interface that facilitates the uploading of fact-based data to factbase 220. Both rule editor 226 and status editor 228 allow the clinician, or others, to interact through various input/output interfaces on the communication device 222 (e.g., keyboard, mouse, touch screen or other graphical user interface, etc.). As such, rule editor 226 may upload new gating rules and customized rules from the collaborating clinician and/or the institution for which the clinician practices, and download such rules to user interface subsystem 210 so that the current rules may be reviewed as needed. Status editor 228 may, for example, upload status information (i.e., fact-based data) in various ways, including automatically at periodic intervals whenever the communication device 222 is operational or connected to the network; when directed by the clinician on the communication device 222; or when polled by the rules subsystem 208 or other component of the system 200.

In one embodiment, the system 200 as described above may be entirely located on the communication device 222 associated with the collaborating clinician. Activity of the system 200 on the communication device 222 may be regulated to be an active process where all of the general component modules 204 and the orchestrator 202 are in a so-called “normal operating mode” simultaneously. Alternatively, system activity may regulated by an on-demand process where at least rules subsystem 208 and user interface subsystem 210 are effectively in a dormant type mode. With the on-demand process, the subsystems 208, 210 become operational when the message handling component 212 receives an inbound message requesting collaboration and the orchestrator 202 provides this information to at least one of the subsystems 208, 210.

The system 200 achieves increased functionality in another embodiment by having certain components redundantly located on at least one server (not shown) within the network, so that “proxy mode” functionality may be achieved when a requesting entity cannot communicatively reach the communication device 222 to engage the system 200. For instance, the I/O and action subsystem 206 and the rules subsystem 208 may be located on both the communication device 222 and a server, with the user interface subsystem 210 preferably located on the communication device 222 only. System activity on a server could also be in the form of an on-demand process that becomes operational when the message handling component 212 receives an inbound message requesting collaboration. In the on-demand server scenario, the orchestrator 202 would preferably be positioned at a location, such as a health care communication network, so that the inability to communicatively reach the device 222 can be determined. The inbound message is then redirected by the orchestrator 202 to the message handling component 212 on the server. On the other hand, the requesting remote entity 400 may be able to contact the message handling component 212 on a server directly. In such a case, the orchestrator 202 in the on-demand server scenario could be located on a server with the I/O and action subsystem 206 and the rules subsystem 208 and become operational when the component 212 receives an inbound message requesting collaboration.

In another embodiment, the user interface subsystem 210 is the only portion of the system 200 located on the communication device 222, with the remaining system elements located on a network server. It should be understood, however, that the positioning of the various functional elements and components of the general component modules 204 as described herein, as well as orchestrator 202, is exemplary. As a matter of design choice, orchestrator 202 may be located on the communication device 222, a server, or other network location. Rearrangement of functional elements and components of the general component modules 204 may be undertaken by those of skill in the art, and is contemplated to be within the scope of the teachings of the present invention. For instance, rule editor 226 may be located on a server or other network location in addition to, or instead of, being located on the communication device 222. This allows institutional entities, authorized to access such a server or network location, to utilize rule editor 226 to edit the rule settings in rulebase 218 without having to use the clinician's communication device 222.

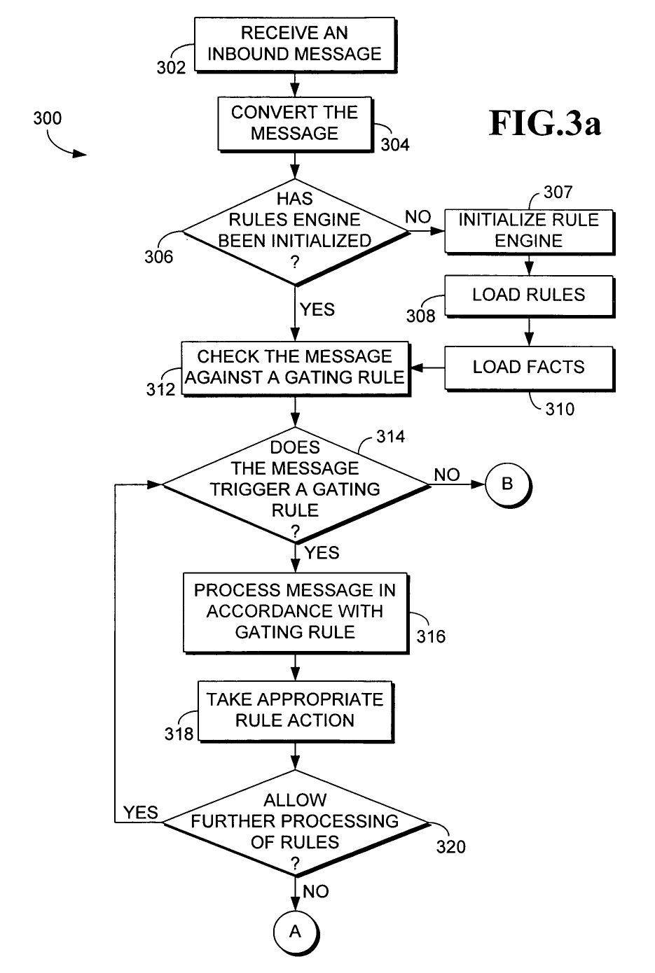

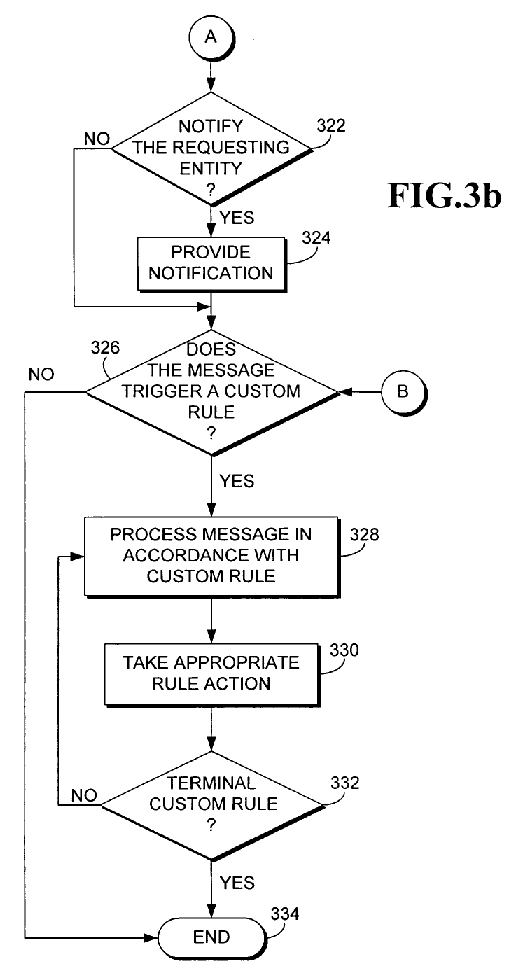

FIG. 3 is a flowchart illustrating one method 300 of implementing the system 200 to process inbound messages requesting collaboration. Inbound messages are received by message handling component 212 in step 302. The inbound message is converted by message handling component 212 in step 304. Depending on the content of the inbound message, the conversion may involve dividing the information within the message into a target context (e.g., patient identifier) and a clinical context (e.g., clinical or medical data pertinent to such patient). The inbound message may also encrypted to prevent unauthorized reading of the message by other entities. In such cases, step 304 also involves decrypting the message.

A determination is then made in step 306 as to whether the rule engine component 216 has been initialized, so that processing of the converted message can take place. If initialization has not taken place, then the rule engine component 216 is initialized in step 307, and then the gating rules and customized rules are loaded into the rule engine component 216 from rulebase 218 in step 308. The status information, or fact-based data from factbase 220, is also loaded into the rule engine component 216 in step 310. Subsequently, in step 312, the content of the converted message is checked against the gating rules. Returning to the determination of step 306, if initialization has taken place, then the method moves directly to step 312.

Turning to step 314, the rule engine component 216 makes a determination as to whether the message triggers a gating rule. For example, the message may contain context about the mode of communication requested for collaboration (e.g., voice), and based on status information loaded in step 310 from factbase 220 about the clinician's communication device 222 (e.g., a PDA without voice capabilities), it can be determined whether collaboration in the chosen communication mode is possible in accordance with the communication capability gating rule. If a gating rule is not triggered, then the method 300 proceeds to step 326 for analysis of any customized rules, as will be more fully explained below. On the other hand, triggering of the gating rule, in step 316, causes message processing to take place in accordance with the gating rule. Thereafter, in step 318, a communication is sent from the rules subsystem 208 to the responder component 214 of the I/O and action subsystem 206 (optionally via the orchestrator 202), and the responder 214 invokes a corresponding rule action 211. Such a rule action 211 may involve in one example transmitting a communication to the requesting entity and/or through notifier 224 to the clinician that collaboration in the specific communication mode is not possible (e.g., no two-way voice capability).

From step 320, a determination is made as to whether further processing of additional gating rules is needed in light of (a) the content of the converted inbound message and/or (b) the status information extracted from factbase 220. If further processing is needed, then the method 300 returns to step 314. If further processing is not needed, then step 322 determines whether the requesting entity is to be notified about the rule action 211 taken, assuming the rule action 211 did not provide the notification. If it is determined that notification should not be given, then the method 300 proceeds directly to step 326 for customized rules analysis. On the other hand, if notification is to be given, then in step 324 such notification is provided to the requesting entity regarding the rule action 211 invoked, and then the method 300 proceeds to step 326.

In step 326, rules engine 216 determines whether the message triggers any customized rules for processing. If so, message processing takes place at step 328 in accordance with the first, or (n=1), customized rule of a possible list of customized rules, and a specific result is generated. For instance, a customized rule may allow for approval of a medication refill if the content of the converted inbound message reveals a proper patient, an approved type of medication for refill, and that the refill is not contraindicated. Thereafter, in step 330, a communication is sent from the rules subsystem 208 to the responder component 214 for invoking a specific corresponding rule action 211. In step 332, a determination is made as to whether the customized rule is a terminal customized rule. The lack of customized rule triggering in step 326, on the other hand, causes the method 300 to reach an endpoint 334.

If the customized rule was not a terminal customized rule, as determined in step 332, then the method 300 returns to repeat step 328 for the n^{th} customized rule of the list used for message processing, where n represents the number of times step 328 has been reached. If the customized rule was in fact a terminal customized rule, then the method reaches endpoint 334.

To provide context to the disclosure above, some example scenarios will be discussed. It should be understood that these examples are merely exemplary and do not limit the invention in any way.

### EXAMPLE 1

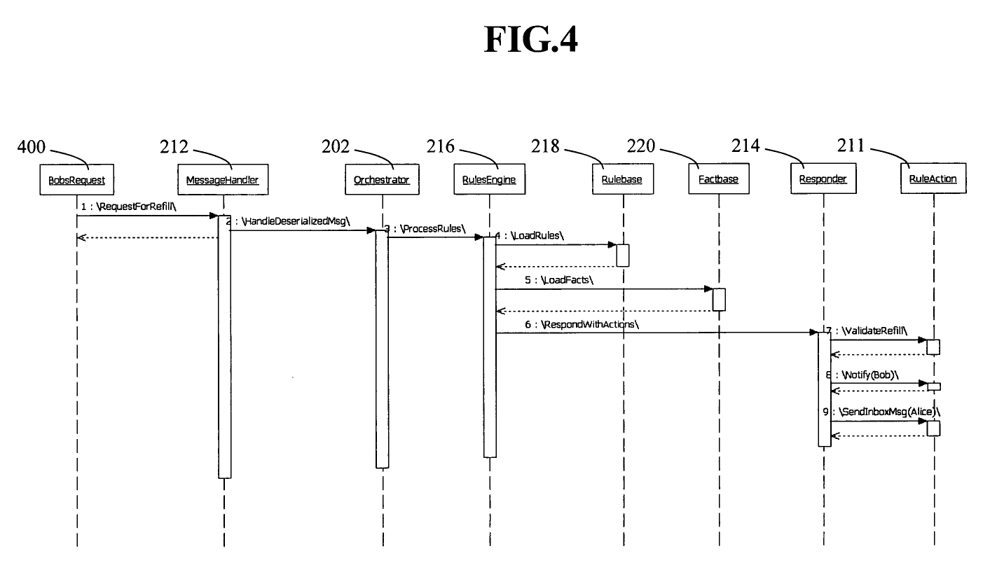

FIG. 4 provides a diagram illustrating the flow of communication through the system 200 in one exemplary scenario for brokering an inbound message requesting collaboration and invoking a specific rule action. The scenario involves a request for collaboration from remote entity 400, in this case, Nurse Bob. The collaborating clinician (Dr. Alice) in this case is a physician that has established a customized rule within rulebase 218 regarding medication refills. Specifically, the refill rule may be stated as follows:
If a request for a medication refill from a class of qualified allergy medications (e.g., Allegra®, Claritin®) comes from a clinician on the care team of a patient for whom the collaborating clinician is the primary care physician, and if it is determined that there would be no interactions based on information in the patient's EMR, then automatically respond with a refill order associated with the medication of an original prescription order, and further send a notification of this event to the collaborating clinician's email inbox and to the communication device of the requesting clinician, otherwise queue an exception to the response to the collaborating clinician's email inbox and to the communication device of the requesting clinician notifying of the failed request.

In line 1, Nurse Bob formulates a request for collaboration around the context of an Allegra® medication renewal for a particular patient (e.g., John Smith, Patient #13456). The request is packaged in the form of an inbound message transmitted electronically across a network from remote communication device 400 associated with Nurse Bob. In line 2, Message handling component 212 of the device 222 associated with Dr. Alice receives and decrypts the message and constructs the de-serialized content including facts about the message. This message conversion, for example, yields: (sender: Nurse Bob; target context: #13456; clinical context medication renewal for Allegra®). In lines 3-5, orchestrator 202 invokes the rules subsystem 208 to compare the converted message to the gating rules and customized rules in view of the fact-base data loaded into the rule engine component 216. This processing step reveals that Dr. Alice's “refill” rule is triggered because Allegra® is a qualified allergy medication. The system 200 examines the message content against certain other pertinent information, for example by using a data source containing drug-drug interaction information and by looking at the patient's EMR. This examination reveals that the target context or patient identifier identifies a patient covered by a care team of which Nurse Bob belongs, and that Dr. Alice is the identified patient's primary care physician. Because there is no contraindication regarding the identified patient taking Allegra®, in line 6 the responder component 214 receives notification of this fact, and selects the appropriate rule actions 211 to invoke. Under this particular scenario, one preferred set of rule actions 211 includes: (1) in line 7, validating the medication refill order, which causes the order to be refilled; (2) in line 8, notifying Nurse Bob of the successful refill via a text message to the remote communication device 400; and (3) in line 9, queuing an inbound email or text message to Dr. Alice notifying of the successful refill of medication.

### EXAMPLE 2

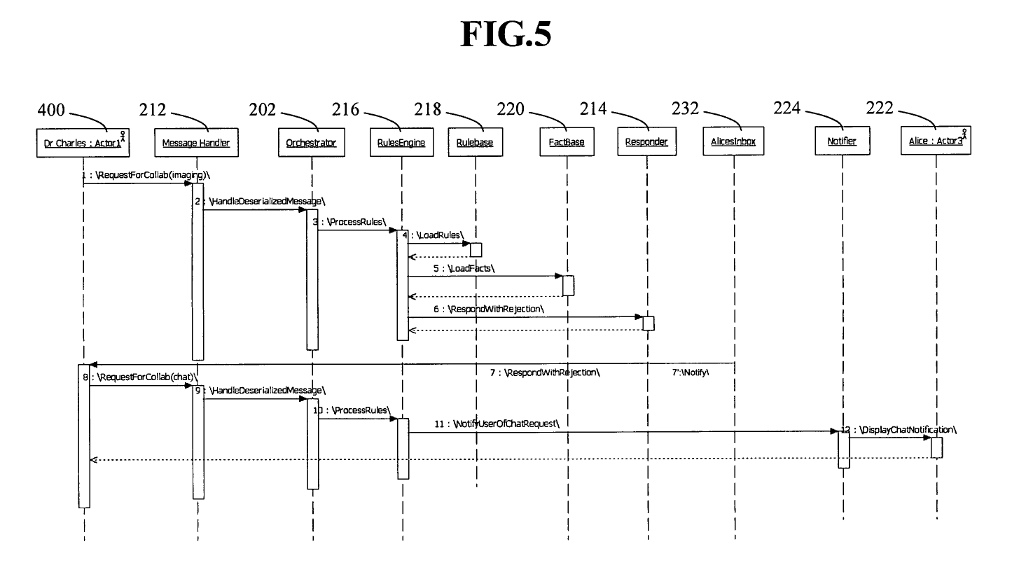

FIG. 5 is another diagram that illustrates the flow of communication through the system 200 in an exemplary scenario for brokering an inbound message requesting collaboration and invoking a specific rule action. With specific reference to FIG. 5, Dr. Alice, as the collaborating clinician, is “present” in the network with communications capabilities via two-way text pager access only, and this fact is registered in factbase 220. Thus, collaboration is only currently available through text messaging. Dr. Alice uses a web interface at user interface subsystem 210 (i.e., connected with the internet or an intranet, such as WAN/LAN) to configure the system 200 with portions thereof located on a network server to establish her presence (i.e., accessibility) as being only through text messaging via a text-pager. Dr. Charles is viewing a patient summary on a device 400 operating in a Windows environment, and wants Dr. Alice's opinion about a particular feature of an echocardiogram. Dr. Charles initiates a request for shared image viewing collaboration in line 1, and the inbound message is received by the message handling component 212 operating on the network server. The inbound message is initially managed in the same way as with scenario 400 (i.e., de-serialized, decrypted and routed through orchestrator 202 to invoke the rules subsystem 208). Rule engine component 216 uses the loaded gating rules and fact-based data from rulebase 218 and factbase 220 to determine that Dr. Alice's type of presence does not support image-based collaboration. In line 6, responder component 214 then receives notification of this fact, and notifies Dr. Charles's device 400 of the inability to support the requested collaboration in line 7. Optionally in line 7′, a message may be queued to Dr. Alice's inbox 232 (e.g., in an email software program) that a failed collaboration attempt has occurred.

Dr. Charles may, at this point, recreate his collaboration request as one for two-way text messaging. The inbound message is received and handled as previously described, and the rules subsystem 208 processes the request and determines that collaboration is possible. A message may be generated and routed to notifier 224 (i.e., through orchestrator 202) noting that a proper collaboration request was received. Collaboration via two-way text messaging can then commence between Dr. Charles and Dr. Alice on their respective devices.

As can be seen, the system and methods of the present invention for accomplishing brokering of requests for an electronic collaboration session with a particular clinician provide for increased efficiencies and selectable functionalities in fostering collaboration in a clinical environment. Furthermore, since certain changes may be made in the above invention without departing from the scope hereof, it is intended that all matter contained in the above description or shown in the accompanying drawing be interpreted as illustrative and not in a limiting sense.

What is claimed is:

1. A method in a computer system of brokering an inbound message on behalf of a particular clinician, the inbound message requesting collaboration with the particular clinician, the method comprising:
receiving the inbound message requesting collaboration;
converting the inbound message into a format suitable for screening;
screening the converted message according to clinical rule settings to reach a particular result; and
generating a response to the converted message based on the result of the screening, the response including invoking a specific rule action.

2. The method of claim 1, wherein the specific rule action invoked includes notifying the particular clinician of the inbound message.

3. The method of claim 2, wherein a client device having certain communication capabilities is associated with the particular clinician, and wherein notifying the clinician of the inbound message includes generating one or more of a visual and audible indication on the client device.

4. The method of claim 1, wherein the inbound message is transmitted from a requesting entity for receipt by the computer system, and wherein invoking a specific rule action includes notifying the requesting entity of whether the particular clinician is accessible for collaboration.

5. The method of claim 1, wherein a client device having certain communication capabilities is associated with the particular clinician, and wherein the specific rule action invoked is based on fact-based data relied upon by the clinical rule settings, the fact-based data including at least one of a clinician-selected availability status, a location of the client device, and a communication capability of the client device of the particular clinician.

6. The method of claim 5, further comprising receiving from the client device the clinician-selected availability status of the client device and editing the clinical rule settings based on the received clinician-selected availability status.

7. The method of claim 5, further comprising receiving from the client device the communication capabilities of the client device and editing the clinical rule settings based on the received communication capabilities without input from the particular clinician.

8. The method of claim 5, wherein the specific rule action invoked includes forwarding a notification of the inbound message to a particular third party.

9. The method of claim 8, wherein screening the converted message according to clinical rule settings to reach a particular result includes:
examining the content of the converted message; and
determining, based on the converted message content and in accordance with the clinical rule settings, whether the particular third party is a qualifying entity for selection to receive the notification of the inbound message.

10. The method of claim 5, wherein the method is performed on a server operating in proxy for the client device.

11. The method of claim 5, wherein the communication capabilities of the client device are determined by the configuration of the client device and the current location of the client device.

12. The method of claim 5, wherein the location of the client device is determined by one of a GPS or LAN-based positioning systems.

13. The method of claim 1, wherein the method is performed on a client device having certain communication capabilities and being associated with the particular clinician as one of an active process and an on-demand process.

14. The method of claim 13, wherein the on-demand process awakens upon receipt of the inbound message.

15. The method of claim 1, wherein the inbound message includes target context and clinical context, and wherein the specific rule action invoked includes performing an action based on the particular target context and clinical context.

16. The method of claim 15, wherein the target context comprises a patient identifier and the clinical context includes clinical data pertinent to a patient associated with the patient identifier.

17. The method of claim 15, wherein the steps of the method are performed without input from the particular clinician.

18. The method of claim 15, wherein the inbound message is transmitted from a requesting entity, the method further comprising notifying at least one of the particular clinician and the requesting entity of the specific rule action invoked.

19. The method of claim 15, wherein the inbound message contains a request and the action performed includes one of approving and disapproving of the request.

20. The method of claim 19, further comprising editing of information in the clinical rule settings based on input received from the particular clinician, wherein the approving or disapproving of the request is at least partially based on the edited information.

21. The method of claim 1, wherein the clinical rule settings include gating rules and customized rules, at least one of the gating rules and customized rules relying upon fact-based data.

22. The method of claim 21, wherein the step of screening the converted message according to clinical rule settings to reach a particular result includes invoking a rules engine to process information contained in the converted message, which comprises:
comparing information in the converted message against the gating rules and fact-based data of the clinical rule settings; and
if the information in the converted message compares favorably to the gating rules and the fact-based data, then comparing information in the converted message against the customized rules.

23. The method of claim 22, wherein the inbound message is transmitted from a requesting entity, and wherein if the information in the converted message does not compare favorably to the gating rules and the fact-based data, then the specific rule action invoked includes notifying the requesting entity that the particular clinician is not accessible for collaboration.

24. The method of claim 21, further comprising editing of the customized rules based on input received from at least one of the particular clinician and a health care institution.

25. The method of claim 21, wherein the fact-based data relied upon by the gating rules includes a schedule for the particular clinician, the schedule dictating a likely location for the particular clinician.

26 A computer system having a processor, a memory and an operating environment, the computer system operable to execute the method as recited in claim 1.

27. A computer-readable medium containing instructions for executing the method of claim 1.

28. A computer system for performing brokering on behalf of a particular clinician of inbound messages requesting collaboration, comprising:
a message handling component for receiving an inbound message and converting the inbound message into a format suitable for screening;
a rule engine component for screening the converted message according to clinical rule settings to reach a particular result; and
a responder component for invoking a specific rule action based on the particular result reached.

29. The computer system of claim 28, further comprising a notifier component for notifying the clinician of the inbound message.

30. The computer system of claim 28, further comprising an editor component for editing the clinical rule settings.

31. The computer system of claim 28, wherein the clinical rule settings include gating rules and customized rules, at least the gating rules relying upon fact-based data.

32. The computer system of claim 31, wherein the rule engine component screens the converted message by comparing information in the converted message against the gating rules and fact-based data of the clinical rule settings, and if the information in the converted message compares favorably to the gating rules and the fact-based data, then comparing information in the converted message against the customized rules.

33. The computer system of claim 31, wherein the editor component including a status editor for editing the fact-based data and a rule editor for editing information within the customized rules.

34. The computer system of claim 31, wherein the fact-based data include the availability status and communication capabilities of a client device associated with the particular clinician, the system being adapted to receive communication signals from and transmit communication signals to the client device.

35. The computer system of claim 31, wherein the clinical rule settings are stored in a rules database and the fact-based data are stored in a fact database.

36. The computer system of claim 28, further comprising an orchestrator component for coordinating the flow of information between at least the message handling component and the rule engine component.

37. The computer system of claim 36, further comprising a notifier component for notifying the clinician of the inbound message, the orchestrator component providing the notifier component with information regarding the inbound message.

38. The computer system of claim 36, wherein the orchestrator component coordinates the flow of information between the rule engine component and the responder component.

39. The computer system of claim 28, wherein a client device having certain communication capabilities is associated with the particular clinician, and wherein at least the message handling component, the rule engine component and the responder component of the system are located on a server operating in proxy mode for the client device.

40. The computer system of claim 28, wherein the particular result reached by the rule engine component is based on target context and clinical context contained in the inbound message.

41. The computer system of claim 28, wherein the inbound message contains a request, the specific rule action invoked by the responder component includes one of approving and disapproving of the request.

42. A computer system for performing brokering on behalf of a particular clinician of inbound messages requesting collaboration that originate from specific entities, comprising:
a message handling component for receiving an inbound message and converting the inbound message into a format suitable for screening;
a rule engine component utilizing clinical rule settings and fact-based data about the particular clinician to screen the converted message to reach a particular result;
a responder component for invoking a specific rule action based on the particular result reached;
a notifier component for notifying the particular clinician of the inbound message; and
an editing component for editing the fact-based data.

43. The computer system of claim 42, wherein the clinical rule settings include gating rules and customized rules, at least the gating rules relying upon fact-based data.

44. The computer system of claim 43, wherein the rule engine component screens the converted message by comparing information in the converted message against the gating rules and fact-based data of the clinical rule settings, and if the information in the converted message compares favorably to the gating rules and the fact-based data, then comparing information in the converted message against the customized rules.

45. The computer system of claim 44, wherein if the information in the converted message does not compare favorably to the gating rules and the fact-based data, then the responder component invokes a specific rule action that includes notifying the requesting entity that the particular clinician is not accessible for collaboration.

46. The computer system of claim 43, wherein the editor component including a status editor for editing the fact-based data and a rule editor for editing information within the customized rules.

47. The computer system of claim 42, wherein the fact-based data about the particular clinician include the availability status and communication capabilities of a client device associated with the particular clinician, the system being adapted to receive communication signals from and transmit communication signals to the client device.

48. The computer system of claim 42, wherein the clinical rule settings are stored in a rules database and the fact-based data are stored in a fact database.

49. The computer system of claim 42, further comprising an orchestrator component for coordinating the flow of information between the message handling component and the rule engine component, and for providing the notifier component with information regarding the inbound message.

50. The computer system of claim 49, wherein the orchestrator component coordinates the flow of information between the rule engine component and the responder component.

51. The computer system of claim 42, wherein a client device having certain communication capabilities is associated with the particular clinician, and wherein at least the message handling component, the rule engine component and the responder component of the system are located on a server operating in proxy mode for the client device.

52. The computer system of claim 42, wherein the particular result reached by the rule engine component is based on target context and clinical context contained in the inbound message.

53. The computer system of claim 42, wherein the inbound message contains a request, the specific rule action invoked by the responder component includes one of approving and disapproving of the request.
